(19) United States
(12) Patent Application Publication
(10) Pub. No.: US 2026/0222541 A1
(43) Pub. Date: Jul. 30, 2026

(54) HARDWARE FRIENDLY DESIGN FOR MODEL PARAMETER DERIVATION WITH NEIGHBORING REGIONS

(71) Applicant: Tencent America LLC, Palo Alto, CA (US)

(72) Inventors: Tianqi LIU, Palo Alto, CA (US); Liang ZHAO, Palo Alto, CA (US); Madhu PERINGASSERY KRISHNAN, Palo Alto, CA (US); Ting-Lan LIN, Palo Alto, CA (US); Jayasingam ADHURAN, Palo Alto, CA (US); Shan LIU, Palo Alto, CA (US)

(21) Appl. No.: 19/321,137

(22) Filed: Sep. 5, 2025

Related U.S. Application Data
(60) Provisional application No. 63/751,799, filed on Jan. 30, 2025.

(51) Int. Cl. H04N 19/105; H04N 19/159; H04N 19/176; H04N 19/186

(52) U.S. Cl. CPC H04N 19/105; H04N 19/159; H04N 19/176; H04N 19/186

(57) ABSTRACT

The various implementations described herein include methods and systems for coding video. In one aspect, a video bitstream includes a current coding block of an image frame. When a multi-hypothesis cross-component prediction (MHCCP) mode is enabled and the current coding block is located at a boundary of a superblock, a computing system extracts a first set of reference samples from a buffer and generates a second set of reference samples based on the extracted reference samples. A plurality of model parameters used in the MHCCP mode are determined for a first chroma sample of the current coding block based on the first set of reference samples and the second set of reference samples. The computing system combines one or more luma samples using the determined model parameters to generate the first chroma sample. The image frame is reconstructed based on the current coding block including the first chroma sample.

### RELATED APPLICATION

This application claims priority to U.S. Provisional Patent Application No. 63/751,799, entitled “Hardware Friendly design for Model Parameter Derivation with Neighboring Regions,” filed Jan. 30, 2025, which is hereby incorporated by reference in its entirety.

### TECHNICAL FIELD

The disclosed embodiments relate generally to video coding, including but not limited to systems and methods for processing video data using cross-component prediction.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released.

### SUMMARY

As mentioned above, encoding (compression) reduces the bandwidth and/or storage space requirements. As described in detail later, both lossless compression and lossy compression can be employed. Lossless compression refers to techniques where an exact copy of the original signal can be reconstructed from the compressed original signal via a decoding process. Lossy compression refers to coding/decoding process where original video information is not fully retained during coding and not fully recoverable during decoding. When using lossy compression, the reconstructed signal may not be identical to the original signal, but the distortion between original and reconstructed signals is made small enough to render the reconstructed signal useful for the intended application. The amount of tolerable distortion depends on the application. For example, users of certain consumer video streaming applications may tolerate higher distortion than users of cinematic or television broadcasting applications. The compression ratio achievable by a particular coding algorithm can be selected or adjusted to reflect various distortion tolerance: higher tolerable distortion generally allows for coding algorithms that yield higher losses and higher compression ratios.

The present disclosure describes cross component intra or inter prediction of video data in a cross component prediction (CCP) mode where each of a plurality of samples of a second color component of a current coding block is determined based on one or more associated samples of a first color component of a reference coding block (e.g., the current coding block itself). The CCP mode corresponds to a multi-tap model that includes a number (N) of taps. Each tap is selected from a sample of the first color component, the one or more associated neighboring samples of the first color component, a nonlinear term, and an offset term. The selected taps are combined using a plurality of model parameters to determine the sample of the second color component. In some embodiments, the sample of the first color component is a luma sample, and the sample of the second color component is a chroma sample. The chroma sample is a weighted combination of terms selected from a respective luma sample, one or more neighboring luma sample, a nonlinear term, and the offset term. In some embodiments, when the CCP mode is enabled for a current coding block, samples of a respective reference area are applied to determine the model parameters. Particularly, in some embodiments, when the current coding block is located at a boundary of a superblock, A first set of reference samples of the respective reference area are extracted from a buffer (e.g., a line buffer), and a second set of reference samples may be generated based on the first set of reference samples.

In some embodiments, when samples of a first color components are applied to determine samples of a second color component, each sample of the first color component is a luma sample, and each sample of the second color component is a blue-difference chroma (Cb) sample or a red-difference chroma (Cr) component. Alternatively, in some embodiments, the first color component is one of the red, green, and blue colors, and the second color component is another one of the red, green, and blue colors. Alternatively, in some embodiments, the first color component and the second component correspond to a color format that is distinct from a YCbCr color format and an RGB color format.

In accordance with some embodiments, a method of video decoding is provided. The method includes receiving a video bitstream including a current image frame. The video bitstream includes a syntax element for a multi-hypothesis cross-component prediction (MHCCP) mode, and the current image frame includes a superblock that further includes a current coding block. The method further includes, based on the syntax element, determining that the MHCCP mode is enabled to reconstruct a first chroma sample of the current coding block based on a set of one or more luma samples. The method further includes, when the current coding block is located at a boundary of a superblock, extracting a first set of reference samples of the current coding block from a buffer and generating a second set of reference samples of the current coding block based on the first set of reference samples. The method further includes determining a plurality of model parameters used in the MHCCP mode for the first chroma sample of the current coding block based on the first set of reference samples and the second set of reference samples, combining the set of one or more luma samples using the plurality of model parameters to generate the first chroma sample of the current coding block, and reconstructing the current image frame including the first chroma sample.

In accordance with some embodiments, a method of video encoding is provided. The method includes receiving video data including a current image frame, and the current image frame includes a superblock that further includes a current coding block. The method further includes encoding the current image frame, transmitting the encoded current image frame via a video bitstream, and signaling, via the video bitstream, the video bitstream includes a syntax element for a multi-hypothesis cross-component prediction (MHCCP) mode indicating whether to reconstruct a first chroma sample of the current coding block based on a set of one or more luma samples. When the MHCCP mode is enabled and the current coding block is located at a boundary of a superblock, the current image frame is reconstructed by extracting a first set of reference samples of the current coding block from a buffer and generating a second set of reference samples of the current coding block based on the first set of reference samples.

In accordance with some embodiments, a method of bitstream conversion is provided. The method includes obtaining a source video sequence including a current image frame, and the current image frame includes a superblock that further includes a current coding block. The method further includes performing a conversion between the source video sequence and a video bitstream. The video bitstream includes the current image frame having the superblock that further includes the current coding block and a syntax element for a multi-hypothesis cross-component prediction (MHCCP) mode indicating whether to reconstruct a first chroma sample of the current coding block based on a set of one or more luma samples. When the MHCCP mode is enabled and the current coding block is located at a boundary of a superblock, the current image frame is reconstructed by extracting a first set of reference samples of the current coding block from a buffer and generating a second set of reference samples of the current coding block based on the first set of reference samples.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder).

In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding. The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIG. 4 illustrates an example scheme for generating a first chroma sample from one or more luma samples in a CCP mode, in accordance with some embodiments.

FIG. 5A is a diagram of an example image frame including a current coding block located at a top boundary of a superblock, in accordance with some embodiments.

FIG. 5B is a diagram of an example image frame including a current coding block located at a left boundary of a superblock, in accordance with some embodiments.

FIGS. 6A-6C are schematic diagrams of an example current image frame where padding reference samples are generated in a duplication padding scheme, a zero padding scheme, and a mirror padding scheme, in accordance with some embodiments, respectively.

FIG. 7 is a schematic diagram of an example current image frame wherein padding reference samples are generated in an interpolation padding scheme, in accordance with some embodiments.

FIG. 8 is a diagram of an example current coding block applying a plurality of filter shapes, in accordance with some embodiments.

FIG. 9 is a flow diagram illustrating an example method of coding video, in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes video compression methods using intra prediction and inter prediction. Samples of a current coding block may be reconstructed from samples of a reference coding block based on a model having a plurality of model parameters. For example, the model is used to predict a chroma sample of the current coding block as a linear or nonlinear weighted sum of multiple inputs of luma samples of the reference coding block, which may be the same as the current coding block. A reference area associated with the current coding block and/or an associated reference coding block includes a plurality of reconstructed neighboring samples (e.g., luma and chroma samples), which are used to determine the plurality of model parameters of the model used to reconstruct the samples of the current coding block. For example, the model parameters may be determined by feeding neighboring reconstructed samples (e.g., in the reference area) of the current coding block and the reference coding block into a least mean square calculation kernel.

In some implementations of this application, when the current coding block is located at a boundary of a superblock, the neighboring reconstructed samples applied to determine the model parameters include a first set of reference samples extracted from a buffer (e.g., a line buffer) and a second set of reference samples (also called padding samples) generated from the first set of reference samples. In an example, the first set of reference samples and the second set of reference samples are located external to, and above a top boundary of, the superblock.

Additionally, in some embodiments, the padding samples may be applied in intra or inter prediction modes using a model based on least mean square optimization, and model parameter of the model are derived using neighboring reconstructed samples in a reference area of the current coding block and an associated reference coding block. In some embodiments, the intra prediction mode can be cross-component prediction modes in which samples of a first color component (e.g., a first chroma sample) are determined using the reconstructed samples (e.g., one or more luma samples) of a second color component, while the current coding block can be a chroma block and the reference coding block can be a co-located luma block. Alternatively, in some embodiments, the intra prediction mode can be an intra block copy mode or an intra template matching mode. Samples of the current coding block are determined using a block vector that can be signaled (e.g., intra block copy) or implicitly derived (e.g., using template matching) to identify the reference coding block. Alternatively, in some embodiments, the inter prediction mode can be an illumination compensation mode, and samples are determined using the neighboring reconstructed samples of the current coding block and the reference coding block in a reference image frame based on a least mean square optimization.

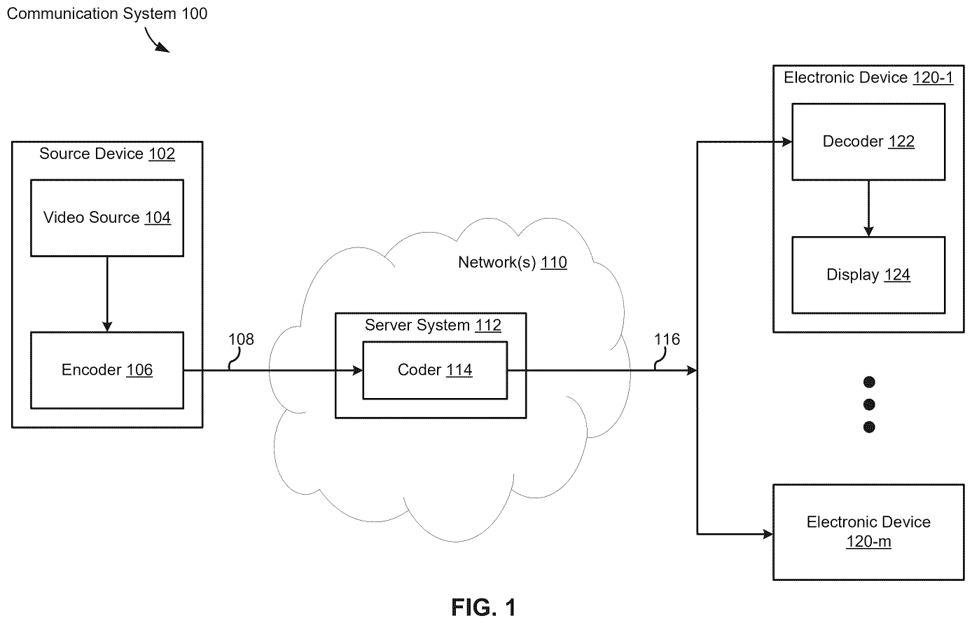

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

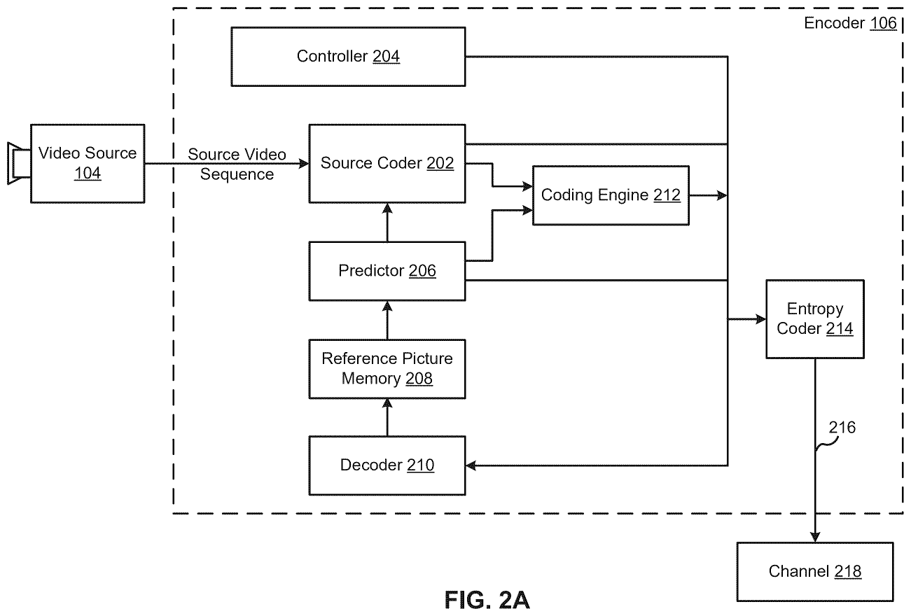

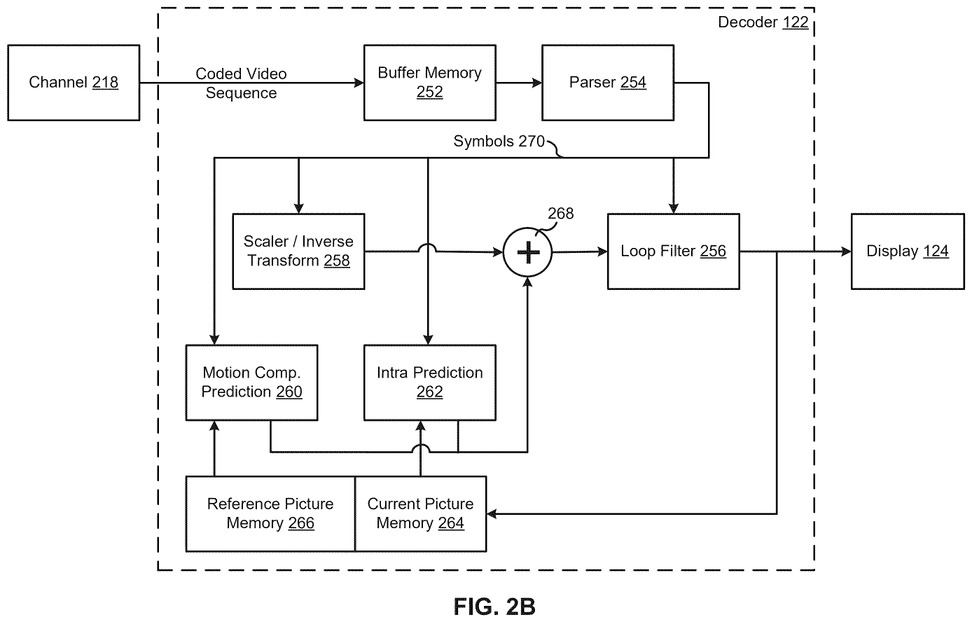

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding. This principle of reference picture synchronicity (and resulting drift, if synchronicity cannot be maintained, for example because of channel errors) is known to a person of ordinary skill in the art.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. The description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, for example, setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, for example, coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, for example, temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, for example, information used to manage operation of the decoder component 122, and/or information to control a rendering device such as the display 124. The control information for the rendering device(s) may be in the form of, for example, Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268.

In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, for example, X, Y, and reference picture components. Motion compensation also can include interpolation of sample values as fetched from the reference picture memory 266 when sub-sample exact motion vectors are in use, motion vector prediction mechanisms, and so forth.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, for example, parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

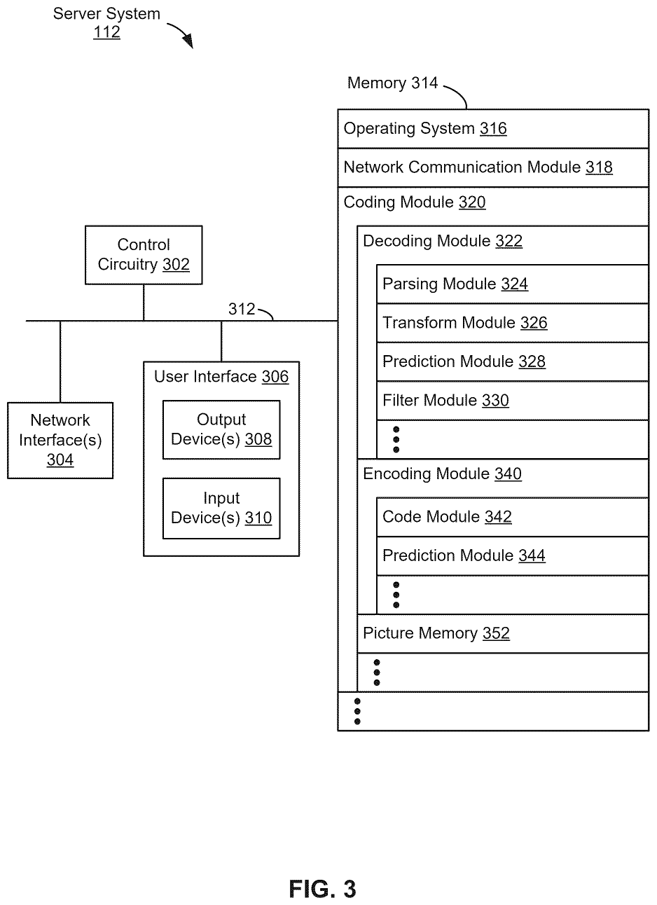

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes one or more field-programmable gate arrays (FPGAs), hardware accelerators, and/or one or more integrated circuits (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above, such as an audio processing module.

Although FIG. 3 illustrates the server system 112 in accordance with some embodiments, FIG. 3 is intended more as a functional description of the various features that may be present in one or more server systems rather than a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

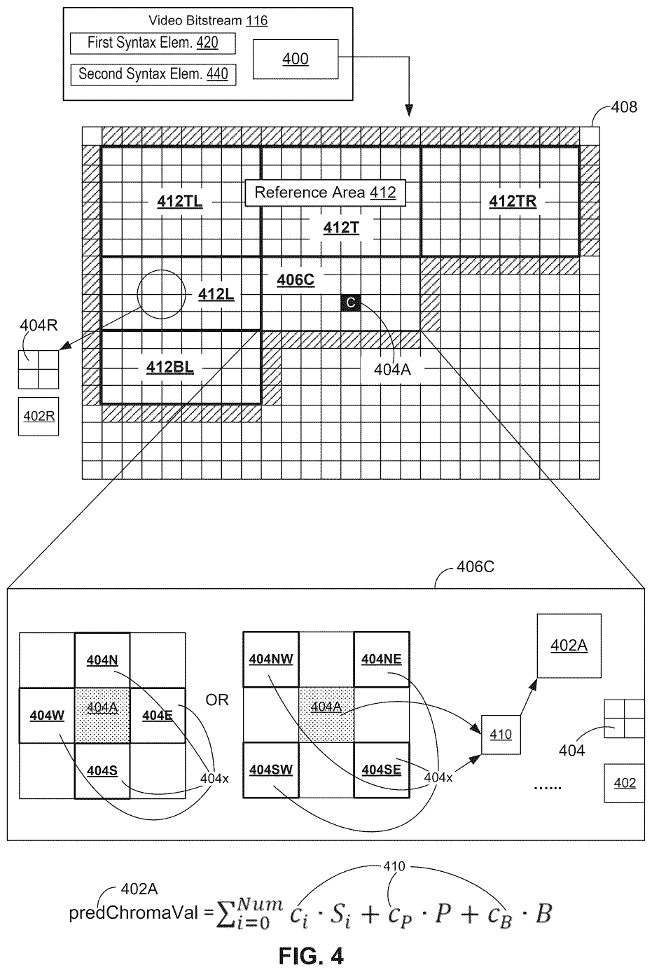

FIG. 4 illustrates an example scheme 400 for generating a first chroma sample 402A from one or more luma samples 404 (e.g., 404A and 404X) in a CCP mode (e.g., a multi-hypothesis CCP (MHCCP) mode), in accordance with some embodiments. In some embodiments, a video bitstream 116 includes a current coding block 406C of the current image frame 408 and a syntax element 420 for the CCP mode. The syntax element 420 indicates whether to reconstruct the first chroma sample 402A of the current coding block 406C based on a set of one or more luma samples 404 of a reference coding block based on a plurality of model parameters 410. Referring to FIG. 4, in an example, the reference coding block is the current coding block 406C itself. In some embodiments, the syntax element 420 is signaled in the video bitstream 116 at one of a block level, a superblock level, an image frame level, a slice level, a tile level, and an image sequence level for the current coding block 406C.

In some embodiments (FIG. 4), the CCP mode includes a cross-component intra prediction (CCIP) mode, and a current coding block 406C of a current image frame 408 is coded in the CCIP mode. In the CCIP mode, the current coding block 406C includes a chroma block, and corresponds to a reference coding block including a co-located luma block. A decoder 122 (FIG. 2B) determines each of a plurality of chroma samples 402 of the current coding block 406C based on one or more luma samples 404 of the reference coding block that have been reconstructed. In some situations, the CCIP mode includes a cross-component linear model (CCLM) mode in which a first chroma sample 402A is converted from a reconstructed luma sample 404A that is co-located with the chroma sample 402A based on a linear model. Alternatively, in some situations, the CCIP mode includes a convolutional cross-component mode (CCCM) in which a first chroma sample 402A is predicted directly from a plurality of reconstructed luma samples 404X that is located adjacent to the first luma sample 404A based on a filter shape of a filter. Alternatively and additionally, in some situations, the CCIP mode includes the MHCCP mode in which a first chroma sample 402A is generated by combining at least the first luma sample 404A that is collocated with the first chroma sample 402A and a plurality of hypothesis values using a plurality of weighing factors. The plurality of neighboring luma samples 404X of the first luma sample 404A are combined using a plurality of coefficients to generate the plurality of hypothesis values. Stated another way, in the MHCCP mode, the first luma sample 404A and the plurality of neighboring luma samples 404X are combined using a plurality of model parameters 410 (which are associated with the weighing factors and the coefficients) to generate the first chroma sample 402A. The first chroma sample 402A is a blue-difference chroma (Cb) sample or a red-difference chroma (Cr) component.

In some embodiments, a video bitstream 116 includes a syntax element 420 for an MHCCP mode. The first chroma sample 402A of the current coding block 406C is configured to be generated by combining at least the first luma sample 404A that is co-located with the first chroma sample 402A and one or more neighboring luma samples 404X of the first luma sample 404A using a plurality of model parameters (e.g., ci, cP, cB). In accordance with a determination that the MHCCP mode is applied, the first chroma sample 402A is predicted according to the following model:

$$predChromaVal = {Σ}_{i = 0}^{N u m} {c}_{i} \cdot {S}_{i} + {c}_{P} \cdot P + {c}_{B} \cdot B \qquad ( 1 )$$

where predChroma Val is a predicted chroma value of the first chroma sample 402A; Num is a total number of neighboring luma samples 404X; Sᵢ is a luma value of the first luma sample 404A (where i is equal to 0) or a neighboring luma sample 404X (where i is greater than 0), which is indexed by i; P is a nonlinear term; B is an offset term; and ci, CP, CB are model parameters. In an example, the nonlinear term P is equal to equal to (C×C+B)>>bit_depth, where C is a sample value of the first luma sample 404A, and bit_depth is the number of bits needed to represent luma samples of the current image frame 408 during encoding and decoding. In some embodiments, B is a median luma value, a middle luma value, or an average luma value of the luma samples 404 of the current coding block 406C. In another example, B is equal to 1<<(bit_depth-1). In the MHCCP mode, the chroma samples 402 of the current coding block 406C do not need to be transmitted in the video bitstream 116, thereby conserving a communication bandwidth of a video codec.

In some embodiments, each of the one or more neighboring luma samples 404X of the first luma sample 404A is immediately adjacent to, and shares at least one respective side or vertex with, the first luma sample 404A. In some embodiments, the one or more neighboring luma samples 404X include a subset or all of a north neighboring luma sample (also called a top luma sample) 404N, a south neighboring luma sample (also called a bottom luma sample) 404S, a west neighboring luma sample (also called a left luma sample) 404 W, an east neighboring luma sample (also called a right luma sample) 404E, a northwest neighboring luma sample (also called a top left luma sample) 404NW, a southeast neighboring luma sample (also called a bottom right luma sample) 404SE, a southwest neighboring luma sample (also called a bottom left luma sample) 404SW, and a northeast neighboring luma sample (also called a top right luma sample) 404NE.

In some embodiments, equation (1) includes five terms, and represents a five tap model for determining the first chroma sample 402A of the current coding block 406C based on three linear terms (e.g., associated with the first luma sample 404A and neighboring luma samples 404W and 404E), the nonlinear term P, and the offset term B in the MHCCP mode. Alternatively, in some embodiments, equation (1) includes seven terms, and represents a seven tap model for determining the first chroma sample 402A of the current coding block 406C based on three linear terms (e.g., associated with luma samples 404A, 404W, 404E, 404N, and 404S), the nonlinear term P, and the offset term B in the MHCCP mode.

In some embodiments, luma samples 404 and chroma samples 402 of the current coding block have different resolutions corresponding to a chroma subsampling scheme (e.g., 4:2:2 or 4:2:0).

In some embodiments, the plurality of model parameters ci, CP, and CB are determined based on a set of one or more reference luma samples 404R and a set of one or more co-located reference chroma samples 402R within a reference area 412 of the current coding block 406C. The reference area 412 is located in the current image frame 408. Further, in some embodiments, the reference luma samples 404R of the reference area 412 are combined to re-generate one or more chroma samples 402A based on equation (1). In some embodiments, the set of one or more co-located reference chroma samples 402R and the one or more re-generated chroma samples are compared to generate a least mean square (LMS) value. The plurality of model parameters ci, Cp, CB are iteratively adjusted to reduce the LMS value, until the LMS value satisfies a predefined criterion (e.g., in which the LMS value is below a threshold LMS value or is minimized).

In some embodiments, the plurality of model parameters ci, CP, or CB are at least partially derived based on chroma samples and luma samples within the reference area 412 of the current coding block 406C, and the reference area 412 includes one or more coding blocks (e.g., 4 coding blocks in FIG. 4) that are decoded prior to, the current coding block 406C. In some embodiments, a subset of the one or more coding blocks is immediately adjacent to the current coding block 406C. In some embodiments, a subset of the one or more coding blocks are separated from the current coding block 406C by one or more coding blocks. In some embodiments, the reference area 412 includes at least a portion of one or more rows above the current coding block 406C and/or a portion of one or more columns to the left of the current coding block 406C. For example, referring to FIG. 4, the reference area 412 includes seven rows of luma samples 404R above the current coding block 406C and nine columns of luma reference samples 404R to the left of the current coding block 406C. The reference area 412 may include a padded row and a padded column (e.g., shaded in FIG. 4).

Additionally, in some embodiments, the reference area 412 of the current coding block 406C includes one or more of: a top left reference region 412TL, a top reference region 412T, a top right reference region 412TR, a bottom left reference region 412BL, and a left reference region 412L. In an example, the reference area 412 includes the top reference region 412T and the left reference region 412L. Each of the reference regions includes one or more coding blocks. Stated another way, in some embodiments, the reference area 412 includes at least a portion of a plurality of rows above the current coding block 406 and/or a portion of a plurality of columns to the left of the current coding block 406. For example, referring to FIG. 4, the reference area 412 includes a first portion of 6 rows of chroma samples above the current coding block 406C and a second portion of 8 columns of chroma samples to the left of the current coding block 406C. A column number of the first portion is determined by a column number of the current coding block 406C, and a row number of the second portion is determined by a row number of the current coding block 406C. In some embodiments, the reference area 412 extends one coding block width to the right of a right boundary of the current coding block 406, and one coding block height below a bottom boundary of the current coding block 406. In some embodiments, the reference area 412 is adjusted to include only available samples. Extensions 412E to the reference area 412 are padded in unavailable areas to provide side samples of a filter.

In some embodiments, the reconstructed luma samples 404R and chroma samples 402R of the reference area 412 are used to generate the model parameters in the CCP mode. The reference area 412 may be L-shaped, including bottom left, left, top left, above and above right reference regions. For example, the reference area 412 has a first integer number K (e.g., 6) of reference lines above the current coding block 406C and a second integer number L (e.g., 8) columns to the left of the current coding block 406C. Extensions 412E to the reference area 412 include padded pixels for the reference samples.

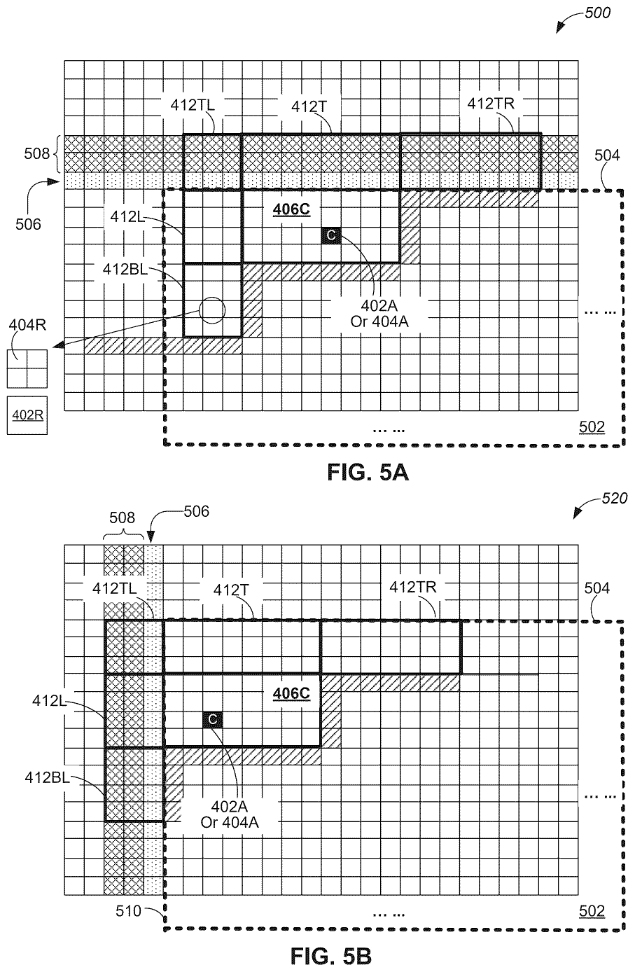

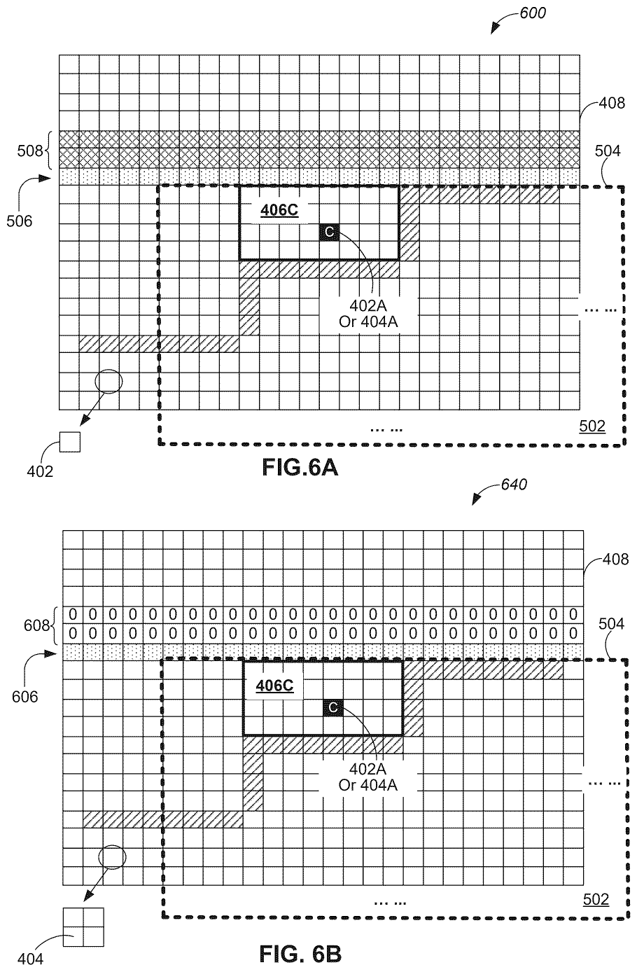

FIG. 5A is a diagram of an example image frame 500 including a current coding block 406C located at a top boundary 504 of a superblock 502, in accordance with some embodiments, and FIG. 5B is a diagram of an example image frame 520 including a current coding block 406C located at a left boundary 510 of a superblock 502, in accordance with some embodiments. In an MHCCP mode, the current coding block 406 is reconstructed based on model parameters 410 determined based on reference samples 402R and 404R of a reference area 412. The reference area 412 includes a first number (N₁) of lines of chroma reference samples 402R and a second number (N₂) of lines of luma reference samples 404R above the current coding block 406C. In an example, the reference area 412 includes three rows of chroma reference samples 402R and eight rows of luma reference samples 404R. A buffer (e.g., a buffer memory 252 in FIG. 2B) stores a first set of reference samples 506. A second set of reference samples 508 is generated from the first set of reference samples 506, e.g., by a padding scheme. A plurality of model parameters 410 used in the MHCCP mode are determined for a first chroma sample 402A of the current coding block 406C based on the first set of reference samples 506 and the second set of reference samples 508. A set of one or more luma samples 404 (e.g., samples 404A and 404X in FIG. 4) of the current coding block 406C are combined using the plurality of model parameters 410 to generate the first chroma sample 402A of the current coding block 406C. The image frame 500 or 520 is reconstructed based on the first chroma sample 402A generated from the set of one or more luma samples 404.

Referring to FIG. 5A, in some embodiments, the current coding block 406C is located at the top superblock boundary 504. A topmost row of luma or chroma samples of the current coding block 406C is defined by, and located immediately adjacent to, the top superblock boundary 504. The first set of reference samples 506 stored in the buffer is located at the top superblock boundary 504, and includes a row of luma reference samples 404R, a row of chroma reference samples 402R, or both. The row of luma samples 404R immediately adjacent to the top superblock boundary 504 may be applied (e.g., duplicated) to generate each of seven remaining rows of luma reference samples 404R of the reference area 412. The row of chroma samples 402R immediately adjacent to the top superblock boundary 504 may be applied (e.g., duplicated) to generate each of two remaining rows of chroma reference samples 402R of the reference area 412, thereby constructing the reference area 412 of the current coding block 406C located at the top superblock boundary 504.

In some embodiments, the first set of reference samples 506 may include an entire row of chroma samples 402R or luma samples 404R. Alternatively, in some embodiments, the first set of reference samples 506 a portion of the row of chroma samples 402R or luma samples 404R (e.g., in reference regions 412TL, 412T, and 412TR). In some embodiments, a left reference region 412L and a bottom left reference region 412BL are located within the current coding block 406C. In some embodiments, the left reference region 412L having a first number of lines (e.g., columns), and the top reference region 412T is located external to the current coding block 406C and has a second number of lines (e.g., rows). The first number is equal to or less than the second number.

Referring to FIG. 5B, in some embodiments, the current coding block 406C is located at the left superblock boundary 510. A leftmost column of luma or chroma samples of the current coding block 406C are defined by, and located immediately adjacent to, the left superblock boundary 510. The first set of reference samples 506 stored in the buffer is located at the left superblock boundary 510, and includes a column of luma reference samples 404R, a column of chroma reference samples 402R, or both. The column of luma samples 404R immediately adjacent to the left superblock boundary 510 may be applied (e.g., duplicated) to generate each of seven remaining columns of luma reference samples 404R of the reference area 412. The column of chroma samples 402R immediately adjacent to the left superblock boundary 510 may be applied (e.g., duplicated) to generate each of two remaining columns of chroma reference samples 402R of the reference area 412, thereby constructing the reference area 412 of the current coding block 406C located at the left superblock boundary 510.

In some embodiments, the first set of reference samples 506 may include an entire column of chroma samples 402R or luma samples 404R. Alternatively, in some embodiments, the first set of reference samples 506 a portion of the column of chroma samples 402R or luma samples 404R (e.g., in reference regions 412TL, 412L, and 412BL). In some embodiments, a top reference region 412T and a top right reference region 412TR are located within the current coding block 406C.

In some embodiments not shown, the current coding block 406C is located at a left top corner of the superblock 502. A topmost sample of a leftmost column of luma or chroma samples of the current coding block 406C is defined by, and located immediately adjacent to, both the top superblock boundary 504 and the left superblock boundary 510. The first set of reference samples 506 includes rows of reference samples 402R and 404R (FIG. 5A), rows of reference samples 402R and 404R (FIG. 5B), or both, so does the second set of reference samples 508 generated from the reference samples 506.

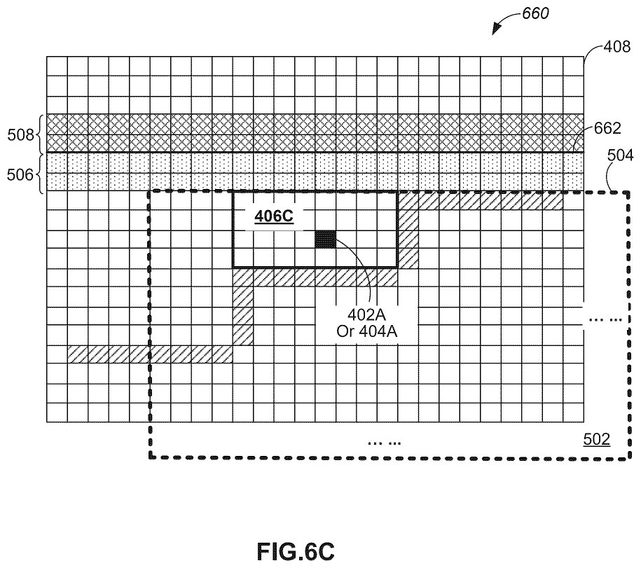

FIGS. 6A-6C are schematic diagrams of an example current image frame 408 where padding reference samples 508 are generated in a duplication padding scheme 600, a zero padding scheme 640, and a mirror padding scheme 660, in accordance with some embodiments, respectively. Referring to FIG. 6A, in some embodiments, in an MHCCP mode, when the current coding block 406C is located at a superblock boundary (e.g., a top superblock boundary 504), a first set of reference samples 506 of the current coding block 406C is extracted from a buffer (e.g., a buffer memory 252 in FIG. 2B), and a second set of reference samples 508 (also called padding reference samples 508) of the current coding block 406C is duplicated from the first of reference samples 506. Alternatively, referring to FIG. 6B, in some embodiments, in an MHCCP mode, when the current coding block 406C is located at a superblock boundary (e.g., a top superblock boundary 504), a third set of reference samples 606 of the current coding block 406C is immediately adjacent to the superblock boundary and extracted from a buffer (e.g., a buffer memory 252 in FIG. 2B). A fourth set of reference samples 608 (also called padding reference samples 608) of the current coding block 406C is set to 0.

In some embodiments, reference chroma samples 402R and reference luma samples 404R are generated based on the duplication padding scheme 600 and the zero padding scheme 640, respectively. For example, in an MHCCP mode, when the current coding block 406C is located at a superblock boundary (e.g., a top superblock boundary 504), a first set of reference samples 506 of the current coding block 406C is extracted from a buffer, and a second set of reference samples 508 of the current coding block 406C is generated based on the first of reference samples 506. Each of the first set of reference samples 506 and the second set of reference samples 508 correspond to a respective chroma reference sample 402R and is included in a reference area 412 of the current coding block 406C. A third set of luma reference samples 606 of the current coding block 406 is extracted from the buffer, and a fourth set of luma reference samples 608 of the current coding block 406C is set to 0. The reference area 412 of the current coding block 406 further includes the third set of luma reference samples 606 and the fourth set of luma reference samples 608.

Alternatively, in another example not shown, each of the first set of reference samples and the second set of reference samples corresponds to a respective luma reference sample 404R and is included in a reference area 412 of the current coding block 406C. A third set of chrome reference samples of the current coding block 406 is extracted from the buffer, and a fourth set of chroma reference samples of the current coding block is set to 0. The reference area 412 of the current coding block 406C further includes the third set of chroma reference samples and the fourth set of chroma reference samples.

Referring to FIG. 6C, in some embodiments, in an MHCCP mode, when the current coding block 406C is located at a superblock boundary (e.g., a top superblock boundary 504), the first set of reference samples 506 and the second set of reference samples 508 of the current coding block 406C may be symmetric with respect to an edge 662 of the first set of reference samples 506 (e.g., the top superblock boundary 504, an edge 662 separating the reference samples 506 and 508). In other words, the second set of reference samples 508 (e.g., both luma and chroma samples) of the current coding block 406C may be generated by mirroring the first set of reference samples 506 with respect to the edge 602. Alternatively, in some embodiments, the second set of reference samples 508 (e.g., luma reference samples) of the current coding block 406C may be generated by mirroring a subset of the current coding block 406C with respect to the top superblock boundary 504.

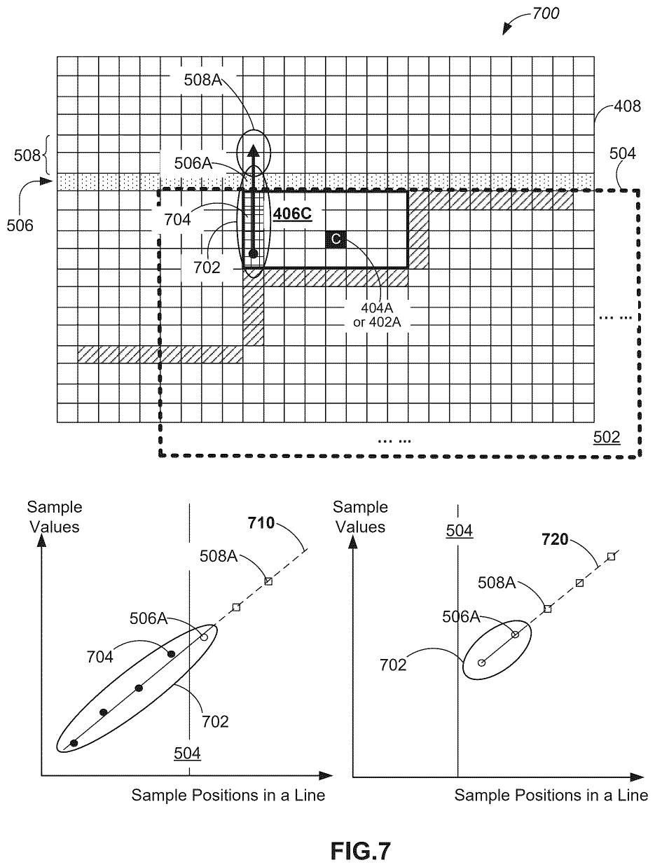

FIG. 7 is a schematic diagram of an example current image frame 408 wherein padding reference samples 508 are generated in an interpolation padding scheme 700, in accordance with some embodiments. In an MHCCP mode, when the current coding block 406C is located at a superblock boundary (e.g., a top superblock boundary 504), A first set of reference samples 506 is extracted from a buffer, and each of a second set of reference samples 508 is extrapolated from a subset 506A of the first set of reference samples 506 located on a row or a column based on linear fitting. In some embodiments, the current coding block 406 is located at a top superblock boundary 504. A column 702 of samples includes the subset 506A of the first set of reference samples 506 and a subset of samples 704 located within the current coding block 406C. Each of a subset 508A of the second of reference samples 508 is aligned with, and interpolated from, the column 702 of samples, e.g., using a first curve 710. In some embodiments, the current coding block 406 is located at a top superblock boundary 504. A column 702 of samples includes the subset 506A of the first set of reference samples 506, but not any sample 702 located within the current coding block 406C. For example, the first set of reference samples 506 may correspond to two or more lines of reference samples, and the subset 506A of reference samples includes two or more reference samples for interpolation of the second set of reference samples 508. Each of a subset 508A of the second of reference samples 508 is aligned with, and interpolated from, the column 702 of samples, e.g., using a second curve 720.

In some embodiments, each of the first set of reference samples 506 and the second set of reference samples 508 correspond to a respective chroma reference sample 402R. The chroma samples 402 of the current coding block 406C are not available yet. A subset 508A of the second set of reference samples 508 is generated by the subset 506A of reference samples external to the current coding block 406C, e.g., using the second curve 720, without applying the chroma samples 402 of the current coding block 406C. Alternatively, in some embodiments, each of the first set of reference samples 506 and the second set of reference samples 508 correspond to a respective luma reference sample 404R. The luma samples 404 of the current coding block 406C are available. A subset 508A of the second set of reference samples 508 is generated by the subset 506A of reference samples external to the current coding block 406C. In an example, the first curve 710 may be applied based on a subset of samples 704 of the current coding block 406C and the subset 506A of reference samples. In another example, the second curve 720 may be applied based on the subset 506A of reference samples without applying the luma samples 404 of the current coding block 406C.

In some embodiments not shown, in an MHCCP mode, when the current coding block 406C is located at a superblock boundary (e.g., a top superblock boundary 504), each of a first set of reference samples 506 and a second set of reference samples 508 correspond to a respective chroma reference sample 402R and is included in a reference area 412 of the current coding block 406C. For example, the second set of reference samples 508 is duplicated from the first set of reference samples 506, e.g., according to a duplication padding scheme in FIG. 5A. A third set of luma reference samples of the current coding block 406C is extracted from the buffer, and a fourth set of luma reference samples may be based on a column 702 of reference samples including at least the third set of luma reference samples, e.g., according to an interpolation padding scheme 700 in FIG. 7. Each of the fourth set of luma reference samples is extrapolated from the column 702 of luma samples based on linear fitting, and the column 702 intersects the top superblock boundary 502.

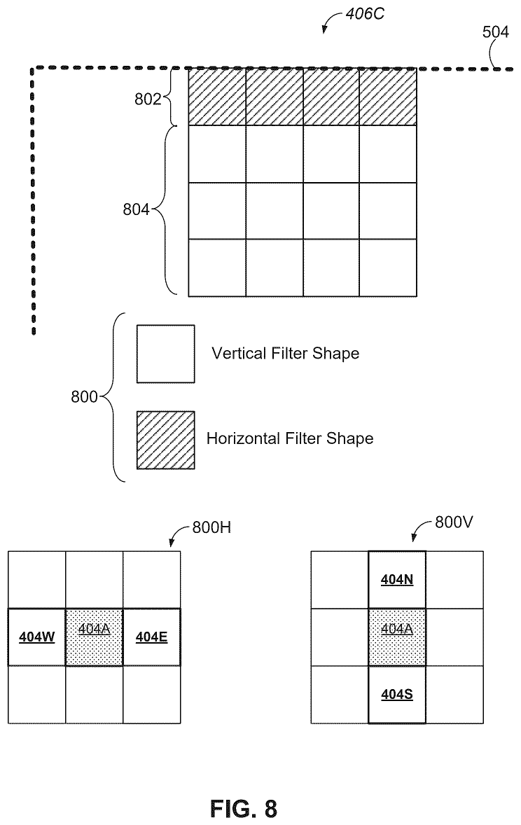

FIG. 8 is a diagram of an example current coding block 404C applying a plurality of filter shapes 800, in accordance with some embodiments. In some embodiments, an MHCCP mode has two different filter shapes 800 including a vertical filter shape 800V and a horizontal filter shape 800H. In some embodiments, a second syntax element 440 (FIG. 4) is signaled into the video bitstream 116 to indicate a selected filter shape selected between the vertical filter shape 800V and the horizontal filter shape 800H. In an example, the second syntax element 440 includes a flag. The selected filter shape has a number of model parameters for prediction (e.g., 5 parameters), and the model parameters are derived for both of the two different filter shapes 800. For the horizontal filter shape 800H, a first luma sample 404A (C), a left luma sample 404W (L), a right luma sample 404E (R), a nonlinear term (E), and an offset term (F) are applied using model parameters c₀, c₁, c₂, c₃, and c₄ to determine a predicted chroma value of the first chroma sample 402A (predChroma Val) as follows:

$$predChromaVal = {c}_{0} C + {C}_{I} L + {c}_{2} R + {c}_{3} E + {c}_{4} F . \qquad ( 2 )$$

For the vertical filter shape 800V, the first luma sample 404A (C), a top luma sample 404N (T), a bottom luma sample 404S (B), a nonlinear term (E), and an offset term (F) are applied using model parameters c₀, c₁, c₂, c₃, and c₄ to determine a predicted chroma value of the first chroma sample 402A (predChroma Val) as follows:

$$predChromaVal = {c}_{0} C + {c}_{1} T + {c}_{2} B + {c}_{3} E + {c}_{4} F . \qquad ( 3 )$$

Further, in some embodiments, for each of the horizontal filter shape 800H and the vertical filter shape 800V, the respective five model parameters are derived by Gaussian elimination based on an LMS optimization.

In some embodiments, the right luma sample 404E (R) and the bottom luma sample 404S (B) are not applied in prediction of the first chroma sample 402A in the MHCCP mode. Equations (2) and (3) for predicting the first chroma sample 402A are updated for the horizontal filter shape 800H and the vertical filter shape 800V as follows:

$$predChromaVal = {c}_{0} C + {c}_{1} L + {c}_{2} E + {c}_{3} F , and \qquad ( 4 )$$

$$predChromaVal = {c}_{0} C + {c}_{1} T + {c}_{2} E + {c}_{3} F . \qquad ( 5 )$$

In some embodiments, the number of the above and the left reference lines are both 3 and 1 padding line in the chroma channels. For 4:2:0 format sequences, the luma channel may require 6 lines and 2 padding lines as the corresponding reference area. In the MHCCP mode, a vertical prediction mode and a horizontal prediction mode are implemented to apply a vertical filter shape 800V and a horizontal filter shape 800H, respectively. For vertical prediction, the first luma sample 404A (C), the top luma sample 404N (T), and the bottom luma sample 404S (B) are combined to generate the first chroma sample 402A (predChroma Val) as follows:

$${predChromaVal}_{h} = {p}_{0}^{h} C + {p}_{1}^{h} L + {p}_{2}^{h} R + {p}_{3}^{h} ( {C}^{2} + m ) + {p}_{4}^{h} m . \qquad ( 6 )$$

where C is the first luma sample; L and R are the left and right luma samples 404W and 404E, respectively; and m is an offset value, representing a middle value of a pixel intensity (e.g., a middle value of a range of luma sample values). For horizontal prediction, the first luma sample 404A (C), the left luma sample 404W (L), and the right luma sample 404E (R) are combined to generate the first chroma sample 402A (predChromaVal) as follows:

$${predChromaVal}_{v} = {p}_{0}^{v} C + {p}_{1}^{v} T + {p}_{2}^{v} B + {p}_{3}^{v} ( {C}^{2} + m ) + {p}_{4}^{v} m , \qquad ( 7 )$$

where T and B are the top and bottom luma samples 404N and 404S, respectively. When the current coding block 406C is located at a superblock or coding tree unit boundary (e.g., a top boundary 504, a left boundary 510), one line of reference samples 506 (FIG. 5A) located above the superblock or coding tree unit boundary is available in the buffer for hardware implementation.

In some embodiments, the current coding block 406C includes a first prediction block 802 that is located at the top superblock boundary 504 and a second prediction block 804 that is separated from the top superblock boundary 504 by the first prediction block 802. The horizontal filter shape 800H is applied to combine a set of luma samples 404 to generate a chroma sample 402 of the first prediction block 802. The vertical filter shape 800V is applied to combine a set of luma samples 404 to generate a chroma sample 402 of the second prediction block 804. Stated another way, in some embodiments, the current coding block 406C has a block-level filter shape (e.g., a vertical filter shape 800V) and includes a first prediction block 802 located immediately adjacent to the boundary 504 and a second prediction block 804 that is separated from the boundary 504 by at least one sample (e.g., of the first prediction block 802). In the MHCCP mode, each chroma sample 402 of the first prediction block 802 is reconstructed based on a respective set of first luma samples 404 using a first filter shape (e.g., a horizontal filter shape 800H), and each chroma sample of the second prediction block 804 is reconstructed based on a respective set of second luma samples using the block-level filter shape (e.g., a vertical filter shape 800V) that is distinct from the first filter shape (e.g., a horizontal filter shape 800H).

In some embodiments, the current coding block 406C has a predefined block-level filter shape corresponding to the plurality of model parameters 410. The current coding block 406C is located at a top boundary 504 of a superblock 502 (FIG. 5A), the predefined block-level filter shape is a horizontal filter shape 800H, and the set of one or more luma samples applied to reconstruct the first chroma sample 402A of the current coding block 406C are located on the same row of a first luma sample 404A that is collocated with the first chroma sample 402A.

In some embodiments not shown, the current coding block has a block-level filter shape and includes a first prediction block located immediately adjacent to a left superblock boundary 510 (FIG. 5B) and a second prediction block that is separated from the boundary by at least one sample. In the MHCCP mode, each chroma sample of the first prediction block 802 (e.g., a column of chroma samples) is reconstructed based on a respective set of first luma samples using a first filter shape (e.g., a horizontal filter shape 800H), and each chroma sample of the second prediction block is reconstructed based on a respective set of second luma samples using a block-level filter shape (e.g., a vertical filter shape 800V) that is distinct from the first filter shape.

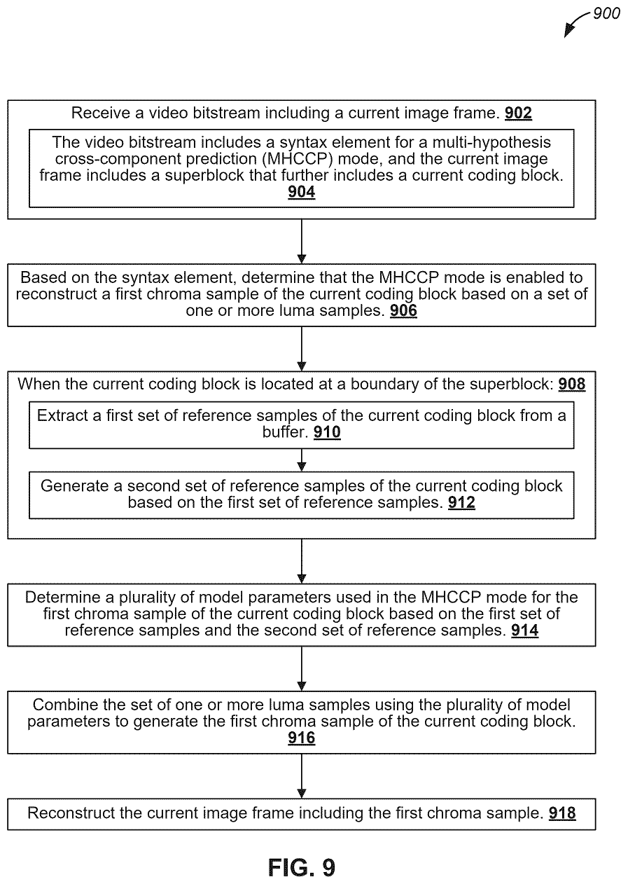

FIG. 9 is a flow diagram illustrating an example method 900 of decoding video, in accordance with some embodiments. The method 900 may be performed at a computing system (e.g., the server system 112, the source device 102, or the electronic device 120) having control circuitry and memory storing instructions for execution by the control circuitry. In some embodiments, the method 900 is performed by executing instructions stored in the memory (e.g., the memory 314) of the computing system. In some embodiments, the method 900 is applied jointly with one or more video codecs, including but not limited to, H.264, H.265/HEVC, H.266/VVC, AV1 and AVS/AVS2/AVS3.

The method 900 is directed to coding a current coding block 406C located at a top boundary 504 of a superblock 502 or a coding tree unit (CTU). A size of a buffer applied to store rows of reference samples is limited. Reference samples in an upper portion of a reference area 412 may be padded, when multi hypothesis cross component prediction is implemented. In some embodiments, for coding blocks at the superblock/CTU top boundary 504, the above line includes a first set of reference samples 506, and can be padded to an integer number (K) of lines based on available samples of top or left reference region(s) (e.g., regions 412TL, 412T, 412TR, 412L, and 412BL) stored in the buffer. The integer value of K may be equal to or smaller than the number of lines in a left reference region 412T. In other words, a total number of rows of reference samples of the top reference region 412T is equal to or less than the number of columns in the left reference region 412T in the reference area 412.

In some embodiments, a duplication padding scheme 600 (FIG. 6) is applied. The reference area 412 includes 8 rows of luma reference samples 404R and 3 rows of chroma reference samples 402R above the current coding block 406C. A row of reference sample 506 is stored in the buffer. The row of reference samples 506 includes a row of luma reference samples and a row of chroma reference samples. Luma and chroma reference samples in the row of reference samples 506 are repeated 7 and 2 times at the top superblock boundary 504, respectively, to build the top reference region 412T. Alternatively, a column of reference sample 506 (FIG. 5B) is stored in the buffer, and repeated one or more times at a left superblock boundary 510 to build the left reference region 412L.

In some embodiments, a zero padding scheme 640 (FIG. 6B) is applied to construct the reference area 412, when blocks are at the superblock or CTU boundary 504 or 510. In a zero padding scheme 640, a padded region of the reference area 412 is filled with reference samples having values equal to 0.

In some embodiments, a mirror padding scheme 660 (FIG. 6C) is applied to construct the reference area 412 when blocks are at the superblock or CTU boundary 504 or 510. The mirror padding means that the padded region is achieved by mirroring samples values with respect to an edge of the first set of reference samples 506 stored in a buffer, creating a reflection of adjacent samples. The edge of the first set of reference samples 506 may be the top superblock boundary 504 or an edge 662 separating the first set of reference samples 506 and the second set of reference samples 508. In some embodiments, the mirror padding scheme 660 is applied to generate luma reference samples 404R and not chroma reference samples 402R.

In some embodiments, an interpolation padding scheme 700 is applied to construct the reference area 412, when a current coding block 406 is located at the top boundary of a superblock/CTU. For instance, linear padding is applied to interpolate the second set of reference samples 508. In an example, each of the second set of reference samples 508 is linearly interpolated from two closest samples lying on the same row or column with the respective reference sample. In some embodiments, the interpolation padding scheme 700 is applied on luma reference samples of the second set of reference samples 508. In some embodiments, the interpolation padding scheme 700 is applied on a subset, but not all, chroma samples of the second set of reference samples 508.

In some embodiments, the current coding block 406C lies at the top boundary of a superblock or CTU, and is reconstructed in an MHCCP mode. Different prediction modes correspond to different filter shapes 800 (FIG. 8) of multi-hypothesis cross component prediction. The different filter shapes 800 are applied to different prediction or transform units based on their locations within the current coding block 406C. Further, on some embodiments, the current coding block 406 uses a vertical MHCCP prediction mode having a vertical filter shape 800V as a default filter shape. A prediction block or transform block located at the top superblock boundary 504 may use a horizontal MHCCP mode having a horizontal filter shape 800H, and prediction or transform units that are not located at the top superblock boundary 504 may use a prediction mode (e.g., the vertical filter shape 800V) signaled at a coding block level. A filter shape of a prediction mode is determined at the coding block level and carried out at a prediction block or transform block level, where a prediction or transform unit is equal to or smaller than a coding block.

In some embodiments, for coding blocks (e.g., a current coding block 406C in FIGS. 5A and 5B) located at the top boundary 504 of a superblock/CTU, an MHCCP mode or other modes are enabled and requires a reference area 412 for parameter derivation. The MHCCP mode or other modes may be implicitly applied without signaling. For example, the MHCCP mode is a horizontal MHCCP mode implicitly applied by default and without signaling.

In some embodiments, coding blocks (e.g., a current coding block 406C) are located at the top boundary 504 of a superblock 502 or a CTU, and modes that require more than one line in the reference area 412 may be implicitly disabled. For example, in some situations, the MHCCP mode requires more than one line in the reference are 412, and is implicitly disabled.

In some embodiments, a line buffer at the left boundary 510 of the superblock 502 or CTU is constrained. The duplication padding scheme 600, zero padding scheme 640, mirror padding scheme 660, and interpolation padding scheme 700 scheme can be adaptively applied to generate reference samples of left reference regions in the reference area 412.

In some embodiments, when a current coding block 406C is located at a left superblock boundary 510, reference samples from up to N left columns can be fetched and employed for deriving MHCCP parameters. When the current coding block 406C is not located at the superblock boundaries 504 and 510, reference samples from up to M rows and/or columns can be fetched and employed for deriving MHCCP parameters. N is smaller than M. Further, in some embodiments, N is the same as the maximum allowed reference lines for intra prediction at the left superblock boundary 510. In some embodiments, the value of N may be different for luma and chroma components for the current coding block 406C located at the left superblock boundary 510. In an example, N is set to 1 for chroma component.

Although FIG. 9 illustrates a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments.

(A1) In some implementations, a method 900 is implemented for decoding video data. The method 900 includes receiving (operation 902) a video bitstream including a current image frame, wherein the video bitstream includes (operation 904) a syntax element for a multi-hypothesis cross-component prediction (MHCCP) mode, and the current image frame includes a superblock that further includes a current coding block; based on the syntax element, determining (operation 906) that the MHCCP mode is enabled to reconstruct a first chroma sample of the current coding block based on a set of one or more luma samples; when the current coding block is located at a boundary of the superblock (operation 908): extracting (operation 910) a first set of reference samples of the current coding block from a buffer; and generating (operation 912) a second set of reference samples of the current coding block based on the first set of reference samples; determining (operation 914) a plurality of model parameters used in the MHCCP mode for the first chroma sample of the current coding block based on the first set of reference samples and the second set of reference samples; combining (operation 916) the set of one or more luma samples using the plurality of model parameters to generate the first chroma sample of the current coding block; and reconstructing (operation 918) the current image frame including the first chroma sample.

(A2) In some implementations of A1, the boundary of the superblock includes a top boundary of the superblock. The first set of reference samples includes a top row of reference samples that is external to, and immediately adjacent to, the top boundary of the superblock, and the second set of reference samples includes one or more successive rows of reference samples located immediately above the top row of reference samples. Each of the one or more successive rows of reference samples replicates the top row of reference samples.

(A3) In some implementations of A2, each reference sample includes a respective luma sample, and the one or more successive rows of reference samples include seven rows of luma samples.

(A4) In some implementations of A2, each reference sample includes a respective chroma sample, and the one or more successive rows of reference samples include two rows of chroma samples.

(A5) In some implementations of any of A1-A4, the current coding block corresponds to a left reference region having a first number of lines and a top reference region that is located external to the current coding block and has a second number of lines. The first number is equal to or less than the second number.

(A6) In some implementations of A1-A5, each of the first set of reference samples and the second set of reference samples corresponds to a respective chroma reference sample and is included in a reference area of the current coding block. The method 900 includes extracting a third set of luma reference samples of the current coding block from the buffer and setting a fourth set of luma reference samples of the current coding block to 0. The reference area of the current coding block further includes the third set of luma reference samples and the fourth set of luma reference samples.

(A7) In some implementations of any of A1-A5, each of the first set of reference samples and the second set of reference samples corresponds to a respective luma reference sample and is included in a reference area of the current coding block. The method 900 includes extracting a third set of chrome reference samples of the current coding block from the buffer and setting a fourth set of chroma reference samples of the current coding block to 0. The reference area of the current coding block further includes the third set of chroma reference samples and the fourth set of chroma reference samples.

(A8) In some implementations of any of A1-A5, each of the first set of reference samples and the second set of reference samples correspond to a respective chroma reference sample and is included in a reference area of the current coding block. The method 900 includes extracting a third set of luma reference samples of the current coding block from the buffer and copying a subset of luma samples of the current coding block to a fourth set of luma reference samples. Each of the fourth set of luma reference samples and a distinct luma sample of the subset of luma samples have symmetric sample positions with respect to the boundary.

(A9) In some implementations of any of A1-A5, each of the first set of reference samples and the second set of reference samples correspond to a respective chroma reference sample and is included in a reference area of the current coding block. The method 900 includes extracting a third set of luma reference samples of the current coding block from the buffer and extrapolating a fourth set of luma reference samples based on the third set of luma reference samples and the current coding block. Each of the fourth set of luma reference samples is extrapolated from a row or a column of luma samples based on linear fitting, the row or the column intersecting the boundary of the superblock.

(A10) In some implementations of any of A1-A5, each of the first set of reference samples and the second set of reference samples correspond to a respective chroma reference sample, and generating the second set of reference samples further includes extrapolating each of the second set of reference samples from a subset of the first set of reference samples located on a row or a column based on linear fitting.

(A11) In some implementations of any of A1-A10, the current coding block has a block-level filter shape and includes a first prediction block located immediately adjacent to the boundary and a second prediction block that is separated from the boundary by at least one sample. In the MHCCP mode, each chroma sample of the first prediction block is reconstructed based on a respective set of first luma samples using a first filter shape, and each chroma sample of the second prediction block is reconstructed based on a respective set of second luma samples using the block-level filter shape that is distinct from the first filter shape.

(A12) In some implementations of A11, the boundary includes a top boundary, and the first filter shape is a horizontal filter shape, and the block-level filter shape is a vertical filter shape.

(A13) In some implementations of any of A1-A12, the current coding block has a predefined block-level filter shape corresponding to the plurality of model parameters. When the current coding block is located at a top boundary of the superblock, the predefined block-level filter shape is a vertical filter shape, and the set of one or more luma samples applied to reconstruct the first chroma sample of the current coding block are located on the same column of a first luma sample that is collocated with the first chroma sample.

(A14) In some implementations of any of A1 and A5-A10, the current coding block has a block-level filter shape and includes a first prediction block located immediately adjacent to the boundary and a second prediction block that is separated from the boundary by at least one sample. In the MHCCP mode, each chroma sample of the first prediction block is reconstructed based on a respective set of first luma samples using a first filter shape, and each chroma sample of the second prediction block is reconstructed based on a respective set of second luma samples using the block-level filter shape that is distinct from the first filter shape. The boundary includes a left boundary, and the first filter shape is a vertical filter shape, and the block-level filter shape is a horizontal filter shape.

(A15) In some implementations of any of A1 and A5-A11, the current coding block has a predefined block-level filter shape corresponding to the plurality of model parameters. When the current coding block is located at a left boundary of the superblock, the predefined block-level filter shape is a horizontal filter shape, and the set of one or more luma samples applied to reconstruct the first chroma sample of the current coding block are located on the same row of a first luma sample that is collocated with the first chroma sample.

(A16) In some implementations of any of A1 and A5-A11, the boundary of the superblock includes a left boundary of the superblock. The first set of reference samples includes one or more first columns of reference samples that are external to, and immediately adjacent to, the left boundary of the superblock, and the second set of reference samples includes one or more successive columns of reference samples located immediately left to the one or more first columns of reference samples. Each of the one or more successive columns of reference samples is generated based on the one or more left columns of reference samples.

(A17) In some implementations of any of A1-16, the boundary of the superblock is one of a left boundary and a top boundary of the superblock.

(A18) In some implementations of any of A1-17, the first set of reference samples and the second set of reference samples are located external to the current coding block and included in a reference area of the current coding block. The reference area of includes a current number of lines of the first set of reference samples and the second set of reference samples.

(A19) In some implementations, a method is implemented for video encoding. The method includes receiving video data including a current image frame, and the current image frame includes a superblock that further includes a current coding block. The method further includes encoding the current image frame, transmitting the encoded current image frame via a video bitstream, and signaling, via the video bitstream, the video bitstream includes a syntax element for a multi-hypothesis cross-component prediction (MHCCP) mode indicating whether to reconstruct a first chroma sample of the current coding block based on a set of one or more luma samples. When the MHCCP mode is enabled and the current coding block is located at a boundary of a superblock, the current image frame is reconstructed by extracting a first set of reference samples of the current coding block from a buffer and generating a second set of reference samples of the current coding block based on the first set of reference samples.

(A20) In some embodiments of A19, the method is implemented to enable the features of any of A2-A18.

(A21) In some implementations, a method is implemented for bitstream conversion. The method includes obtaining a source video sequence including a current image frame, and the current image frame includes a superblock that further includes a current coding block. The method further includes performing a conversion between the source video sequence and a video bitstream. The video bitstream includes the current image frame having the superblock that further includes the current coding block and a syntax element for a multi-hypothesis cross-component prediction (MHCCP) mode indicating whether to reconstruct a first chroma sample of the current coding block based on a set of one or more luma samples. When the MHCCP mode is enabled and the current coding block is located at a boundary of a superblock, the current image frame is reconstructed by extracting a first set of reference samples of the current coding block from a buffer and generating a second set of reference samples of the current coding block based on the first set of reference samples.

(A22) In some embodiments of A21, the method is implemented to enable the features of any of A2-A18.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A22 above).

In yet another aspect, some embodiments include a non-transitory computer-readable storage medium storing one or more sets of instructions for execution by control circuitry of a computing system, the one or more sets of instructions including instructions for performing any of the methods described herein (e.g., A1-A22 above).

Unless otherwise specified, any of the syntax elements described herein may be high-level syntax (HLS). As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if”′ can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method for decoding video data, comprising:
receiving a video bitstream including a current image frame, wherein the video bitstream includes a syntax element for a multi-hypothesis cross-component prediction (MHCCP) mode, and the current image frame includes a superblock that further includes a current coding block;
based on the syntax element, determining that the MHCCP mode is enabled to reconstruct a first chroma sample of the current coding block based on a set of one or more luma samples;
when the current coding block is located at a boundary of the superblock:
extracting a first set of reference samples of the current coding block from a buffer; and
generating a second set of reference samples of the current coding block based on the first set of reference samples;
determining a plurality of model parameters used in the MHCCP mode for the first chroma sample of the current coding block based on the first set of reference samples and the second set of reference samples;
combining the set of one or more luma samples using the plurality of model parameters to generate the first chroma sample of the current coding block; and
reconstructing the current image frame including the first chroma sample.

2. The method of claim 1, wherein:
the boundary of the superblock includes a top boundary of the superblock;
the first set of reference samples includes a top row of reference samples that is external to, and immediately adjacent to, the top boundary of the superblock, and the second set of reference samples includes one or more successive rows of reference samples located immediately above the top row of reference samples; and
each of the one or more successive rows of reference samples replicates the top row of reference samples.

3. The method of claim 2, wherein each reference sample includes a respective luma sample, and the one or more successive rows of reference samples include seven rows of luma samples.

4. The method of claim 2, wherein each reference sample includes a respective chroma sample, and the one or more successive rows of reference samples include two rows of chroma samples.

5. The method of claim 1, wherein:
the current coding block corresponds to a left reference region having a first number of lines and a top reference region that is located external to the current coding block and has a second number of lines; and
the first number is equal to or less than the second number.

6. The method of claim 1, wherein each of the first set of reference samples and the second set of reference samples corresponds to a respective chroma reference sample and is included in a reference area of the current coding block, the method further comprising:
extracting a third set of luma reference samples of the current coding block from the buffer; and
setting a fourth set of luma reference samples of the current coding block to 0, wherein the reference area of the current coding block further includes the third set of luma reference samples and the fourth set of luma reference samples.

7. The method of claim 1, wherein each of the first set of reference samples and the second set of reference samples corresponds to a respective luma reference sample and is included in a reference area of the current coding block, the method further comprising:
extracting a third set of chrome reference samples of the current coding block from the buffer; and
setting a fourth set of chroma reference samples of the current coding block to 0, wherein the reference area of the current coding block further includes the third set of chroma reference samples and the fourth set of chroma reference samples.

8. The method of claim 1, wherein each of the first set of reference samples and the second set of reference samples correspond to a respective chroma reference sample and is included in a reference area of the current coding block, the method further comprising:
extracting a third set of luma reference samples of the current coding block from the buffer; and
copying a subset of luma samples of the current coding block to a fourth set of luma reference samples, wherein each of the fourth set of luma reference samples and a distinct luma sample of the subset of luma samples have symmetric sample positions with respect to the boundary.

9. The method of claim 1, wherein each of the first set of reference samples and the second set of reference samples correspond to a respective chroma reference sample and is included in a reference area of the current coding block, the method further comprising:
extracting a third set of luma reference samples of the current coding block from the buffer; and
extrapolating a fourth set of luma reference samples based on the third set of luma reference samples and the current coding block, wherein each of the fourth set of luma reference samples is extrapolated from a row or a column of luma samples based on linear fitting, the row or the column intersecting the boundary of the superblock.

10. The method of claim 1, wherein each of the first set of reference samples and the second set of reference samples correspond to a respective chroma reference sample, and generating the second set of reference samples further comprises extrapolating each of the second set of reference samples from a subset of the first set of reference samples located on a row or a column based on linear fitting.

11. The method of claim 1, wherein:
the current coding block has a block-level filter shape and includes a first prediction block located immediately adjacent to the boundary and a second prediction block that is separated from the boundary by at least one sample; and
in the MHCCP mode, each chroma sample of the first prediction block is reconstructed based on a respective set of first luma samples using a first filter shape, and each chroma sample of the second prediction block is reconstructed based on a respective set of second luma samples using the block-level filter shape that is distinct from the first filter shape.

12. The method of claim 11, wherein the boundary includes a top boundary, and the first filter shape is a horizontal filter shape, and the block-level filter shape is a vertical filter shape.

13. The method of claim 1, wherein:
the current coding block has a predefined block-level filter shape corresponding to the plurality of model parameters; and
when the current coding block is located at a top boundary of the superblock, the predefined block-level filter shape is a vertical filter shape, and the set of one or more luma samples applied to reconstruct the first chroma sample of the current coding block are located on the same column of a first luma sample that is collocated with the first chroma sample.

14. The method of claim 1, wherein:
the current coding block has a block-level filter shape and includes a first prediction block located immediately adjacent to the boundary and a second prediction block that is separated from the boundary by at least one sample; and
in the MHCCP mode, each chroma sample of the first prediction block is reconstructed based on a respective set of first luma samples using a first filter shape, and each chroma sample of the second prediction block is reconstructed based on a respective set of second luma samples using the block-level filter shape that is distinct from the first filter shape; and
the boundary includes a left boundary, and the first filter shape is a vertical filter shape, and the block-level filter shape is a horizontal filter shape.

15. The method of claim 1, wherein:
the current coding block has a predefined block-level filter shape corresponding to the plurality of model parameters; and
when the current coding block is located at a left boundary of the superblock, the predefined block-level filter shape is a horizontal filter shape, and the set of one or more luma samples applied to reconstruct the first chroma sample of the current coding block are located on the same row of a first luma sample that is collocated with the first chroma sample.

16. The method of claim 1, wherein:
the boundary of the superblock includes a left boundary of the superblock;
the first set of reference samples includes one or more first columns of reference samples that are external to, and immediately adjacent to, the left boundary of the superblock, and the second set of reference samples includes one or more successive columns of reference samples located immediately left to the one or more first columns of reference samples; and
each of the one or more successive columns of reference samples is generated based on the one or more first columns of reference samples.

17. The method of claim 1, wherein the boundary of the superblock is one of a left boundary and a top boundary of the superblock.

18. The method of claim 1, wherein:
the first set of reference samples and the second set of reference samples are located external to the current coding block and included in a reference area of the current coding block; and
the reference area of includes a current number of lines of the first set of reference samples and the second set of reference samples.

19. A computing system, comprising:
control circuitry; and
memory storing one or more programs configured to be executed by the control circuitry, the one or more programs further comprising instructions for:
receiving video data including a current image frame, wherein the current image frame includes a superblock that further includes a current coding block;
encoding the current image frame;
transmitting the encoded current image frame via a video bitstream; and
signaling, via the video bitstream, the video bitstream includes a syntax element for a multi-hypothesis cross-component prediction (MHCCP) mode indicating whether to reconstruct a first chroma sample of the current coding block based on a set of one or more luma samples;
wherein when the MHCCP mode is enabled and the current coding block is located at a boundary of a superblock, the current image frame is reconstructed by extracting a first set of reference samples of the current coding block from a buffer and generating a second set of reference samples of the current coding block based on the first set of reference samples.

20. A non-transitory computer-readable storage medium storing one or more programs for execution by control circuitry of a computing system, the one or more programs comprising instructions for:
obtaining a source video sequence including a current image frame, wherein the current image frame includes a superblock that further includes a current coding block; and
performing a conversion between the source video sequence and a video bitstream, wherein the video bitstream comprises:
the current image frame having the superblock that further includes the current coding block; and
a syntax element for a multi-hypothesis cross-component prediction (MHCCP) mode indicating whether to reconstruct a first chroma sample of the current coding block based on a set of one or more luma samples;
wherein when the MHCCP mode is enabled and the current coding block is located at a boundary of a superblock, the current image frame is reconstructed by extracting a first set of reference samples of the current coding block from a buffer and generating a second set of reference samples of the current coding block based on the first set of reference samples.
